(19) United States
(12) Patent Application Publication
(10) Pub. No.: US 2015/0180297 A1
(43) Pub. Date: Jun. 25, 2015

(54) Method for Producing a Rotor Unit

(71) Applicant: Robert Bosch GmbH, Stuttgart (DE)

(72) Inventors: Retamero Wagner, Campinas - Sao Paulo (BR); Edmar Lopes, Stuttgart (DE); Gyoergy Mucsi, Ditzingen (DE); Achim Duesselberg, Kirchheim/Teck (DE)

(21) Appl. No.: 14/403,563

(22) PCT Filed: Apr. 24, 2013
(86) PCT No.: PCT/EP2013/058417

§ 371 Date: Nov. 24, 2014

(30) Foreign Application Priority Data
May 25, 2012 (DE) 10 2012 208 848.2

(51) Int. Cl. H02K 3/30; H02K 15/10

(52) U.S. Cl. CPC H02K 3/30; H02K 15/105

(57) ABSTRACT

A method for producing a rotor unit that has at least one armature element with at least one winding includes applying at least one matrix material to the at least one winding so as to at least partially fix the at least one winding. The matrix material is applied to the at least one winding together with protective particles configured to protect the at least one winding in an operating state.

### PRIOR ART

Methods for producing a rotor unit, which has at least one armature element with at least one winding, having a step in which at least one matrix material intended at least partially for fixing the at least one winding is applied to the at least one winding, are already known.

### DISCLOSURE OF THE INVENTION

The invention proceeds from a method for producing a rotor unit, which has at least one armature element with at least one winding, having a step in which at least one matrix material intended at least partially for fixing the at least one winding is applied to the at least one winding.

It is proposed that the matrix material is applied to the at least one winding together with protective particles, which are intended for protecting the at least one winding in an operating state. In this context, an “armature element” is to be understood as meaning in particular an element of an electrical drive apparatus, in particular of an electric motor, which is intended to perform a rotational motion in at least one operating state of the electrical drive apparatus. “Intended” is to be understood as meaning in particular especially configured, designed and/or equipped. In this context, a “winding” is to be understood as meaning in particular an element which is formed at least partially from a wire which is intended in particular to be subjected to the throughflow of an electric current and which has at least one turn. In this context, a “matrix material” is to be understood as meaning in particular a material and/or a material mixture which is intended for fastening the at least one winding and/or for embedding at least one element, in particular at least the at least one winding. The matrix material is preferably formed by a synthetic resin, particularly preferably by an impregnating resin. In this context, “fixing” is to be understood as meaning in particular at least substantially fixed fastening. In this context, “at least substantially fixed” is to be understood as meaning in particular that the winding can be moved away from a fixing point in particular by less than 5 mm, preferably by less than 3 mm and particularly preferably by less than 1 mm. In this context, a “protective particle” is to be understood as meaning in particular an element which is intended to protect the at least one winding at least partially, preferably at least almost completely, against damage, and which has a greatest extent measuring preferably at most 4 mm and particularly preferably at most 3 mm. It is preferable that the protective particles at least partially, preferably at least almost completely, have a greater hardness than the matrix material and/or the at least one winding. The protective particles are preferably formed from a ceramic, a glass, an organic material, an inorganic material and/or a polymer material and/or from any other material which appears to be expedient to a person skilled in the art. In this context, “together” is to be understood as meaning at the same time and/or in a single working step.

Preferably good protection of the at least one winding of the rotor unit can be achieved by the configuration according to the invention in an advantageously simple, cost-effective and fast manner. Furthermore, preferably reliable protection of the at least one winding of the rotor unit can be achieved by means of minimal manufacturing outlay. For this purpose, it is possible to draw at least substantially on already existing systems, in particular for carrying out an impregnation process for applying the matrix material to the at least one winding, as a result of which high investment costs can be avoided. In addition, it is possible to prevent an increase in required space and also process time.

Furthermore, it is proposed that the matrix material and the protective particles are at least partially mixed with one another before they are applied to the at least one winding. In this context, “mixed” is to be understood as meaning in particular that the matrix material and the protective particles are combined, i.e. blended, to form an at least approximately homogeneous substance mixture. In a particularly preferred exemplary embodiment, an additive material is furthermore added, as a result of which it is possible to achieve particularly good and uniform mixing of the protective particles and of the matrix material. It is thereby possible to achieve an advantageously simple and preferably fast application of the protective particles in a single working step.

In addition, it is proposed that the matrix material and/or the protective particles are distributed at least substantially uniformly over at least one part of the at least one winding. In this context, “distributed at least substantially uniformly” is to be understood as meaning in particular that distances between the protective particles and/or a thickness of the matrix material differ from one another in particular by at most 30%, preferably by at most 20%, with preference by at most 10% and particularly preferably by at most 5%, and/or that in each case an at least approximately identical number of protective particles are arranged on sub-segments of identical size and/or shape, into which the entire area of extent of the matrix material is divided. As a result, it is possible to achieve advantageously good protection of the at least one winding. In addition, it is possible to achieve a preferably small imbalance of the rotor unit in an operating state of the electrical drive apparatus.

Furthermore, it is proposed that the method comprises at least one further step, in which the matrix material is at least partially cured. The curing of the matrix material can advantageously be assisted and/or accelerated by the supply of light waves, in particular in an ultraviolet range, by the supply of heat or by any other methods which appear to be expedient to a person skilled in the art. As a result, it is advantageously possible to shorten the production time for the rotor unit.

The invention moreover proposes a rotor unit of an electrical drive apparatus, which has been produced by means of the method according to the invention.

As a result, preferably good protection of the at least one winding of the rotor unit can be achieved in an advantageously simple, cost-effective and fast manner. In addition, it is possible to achieve a configuration for the protection of the at least one winding with a reduced number of components, in particular with additional components being avoided.

Moreover, it is proposed that the matrix material comprises at least one resin. In this context, a “resin” is to be understood as meaning in particular a material which, in at least one state, in particular in at least one processing state, has a viscosity of between 700 mPa s and 10 000 mPa s, the viscosity of which increases during curing and which, in a cured state, is infusible and has thermosetting properties.

The resin of the matrix material is preferably formed by a synthetic resin, particularly preferably by an impregnating resin. It is thereby possible to achieve a preferably simple application and also advantageously reliable and cost-effective fixing of the at least one winding.

Furthermore, it is proposed that the protective particles are arranged in a manner distributed at least substantially uniformly over a surface of the at least one winding. In this context, “at least substantially uniformly” is to be understood as meaning in particular that the distances between the protective particles differ from one another in particular by at most 30%, preferably by at most 20%, with preference by at most 10% and particularly preferably by at most 5%. As a result, it is possible to achieve advantageously good protection of the at least one winding. In addition, it is possible to achieve a preferably small imbalance of the rotor unit in an operating state of the electrical drive apparatus.

In addition, it is proposed that the protective particles have at least one extent which measures at least 0.5 mm. In a particularly preferred exemplary embodiment, the protective particles have a greatest extent which measures in particular between 0.5 mm and 4 mm. In a particularly preferred exemplary embodiment, the size of the protective particles varies, such that at least substantially the entire range of the predefined size values for the protective particles can be covered. Furthermore, the protective elements can also differ from one another in the configuration of the outer contours and shapes and also in the selection of the materials. It is thereby possible to achieve an advantageously light configuration of the protective particles, as a result of which an advantageously small imbalance of the rotor unit can be achieved in an operating state of the electrical drive apparatus. In addition, preferably good and reliable protection of the at least one winding can be achieved by the protective particles.

Furthermore, it is proposed that the protective particles are arranged at least substantially spaced apart from one another. In this context, “at least substantially spaced apart from one another” is to be understood as meaning in particular that in each case a distance of at least 1 mm, preferably of at least 3 mm, with preference of at least 5 mm and particularly preferably of at least 10 mm is provided between at least a majority of the individual protective particles. As a result, it is possible to achieve a preferably good removal of heat from the winding to a surrounding area in an operating state, since at least part of the surface of the at least one winding remains uncovered by virtue of this configuration.

In addition, it is proposed that the protective particles at least substantially have a geometrically undefined shape. In this context, “at least substantially geometrically undefined” is to be understood as meaning in particular that a contour of the cutting particles differs at least partially from an, in particular uniform, geometrical shape. It is preferable that the shapes of the contours of the protective particles differ from one another at least for the most part. It is also conceivable, however, that the protective particles have a geometrically defined shape, for example a spherical shape, a cube shape, a cylindrical shape or any other shapes which appear to be expedient to a person skilled in the art. It is thereby possible to achieve an advantageously simple and cost-effective configuration of the protective particles.

Moreover, it is proposed that the protective particles are formed at least partially from an electrically non-conductive material. In this context, an “electrically non-conductive material” is to be understood as meaning in particular a material which has insulating properties with respect to an electric current. It is thereby possible to achieve preferably high and reliable protection of the at least one winding.

### DRAWING

Further advantages become apparent from the following description of the drawing. The drawing shows two exemplary embodiments of the invention. The drawing, the description and the claims contain numerous features in combination. A person skilled in the art will expediently also consider the features individually and combine them to form expedient further combinations.

In the drawing:

FIG. 1 shows a schematic side view of a rotor unit of an electrical drive apparatus,

FIG. 2 shows a perspective illustration of a section of the rotor unit according to the invention in the region of a winding head with a fixing unit and protective particles,

FIG. 3 shows a perspective illustration of a section of a rotor unit of alternative configuration in the region of a winding head with a fixing unit and protective particles, and

FIG. 4 shows a flow chart for a method for producing the rotor unit according to the invention.

### DESCRIPTION OF THE EXEMPLARY EMBODIMENTS

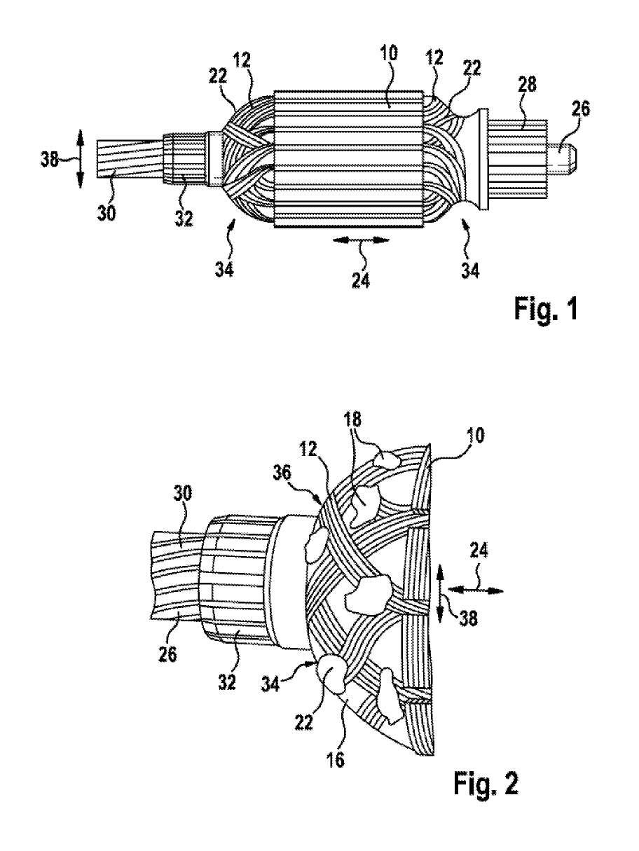

FIG. 1 shows a rotor unit of an electrical drive apparatus which has an armature element 10. The electrical drive apparatus is formed by an electric motor and is intended to drive an electrical portable power tool. The armature element 10 is formed from iron. The armature element 10 is formed from iron sheets stacked one on top of another. The armature element 10 has grooves (not shown in greater detail), into which at least one winding 12 extends. The armature element 10 has a plurality of windings 12. The windings 12 are connected to a commutator (not shown). The windings 12 run via a winding head 22 of the armature element 10. The armature element 10 has two winding heads 22, which are arranged lying opposite one another in a main direction of extent 24 of the armature element 10. The main direction of extent 24 of the armature element 10 runs parallel to an armature shaft 26 of the rotor unit.

The windings 12 are arranged in a manner crossing over one another in the region of the winding head 22. The windings 12 are intended to be subjected to the throughflow of an electric current in an operating state, as a result of which a magnetic field is induced. In an operating state, the induced magnetic field interacts with a magnetic field of a stator unit (not shown) of the electrical drive apparatus.

Furthermore, the rotor unit has a drive toothing system 28 and a driven toothing system 30. The drive toothing system 28 and the driven toothing system 30 enclose the winding heads 22 and also the armature element 10 in the main direction of extent 24. A receiving element 32 is arranged in addition between one of the winding heads 22 and the driven toothing system 30 and is intended for receiving a fan element (not shown) for cooling the electrical drive apparatus in an operating state.

FIG. 2 shows a section of the rotor unit, in which a fixing unit 34 intended for fixing the windings 12 on the armature element 10 is arranged on the winding head 22. The fixing unit 34 comprises a matrix material 16, which is uniformly applied in trickles in a fluid state to the windings 12 of the winding head 22. The matrix material 16 forms the fixing unit 34. The matrix material 16 penetrates into the interstices of the windings 12 and fills these at least partially. The fixing unit 34 prevents slipping of the windings 12 on the armature element 10 in an operating state.

Furthermore, a protective unit 36 is arranged in the region of the winding head 22 of the armature element and is intended for protecting the at least one winding 12 in an operating state. The protective unit is intended to prevent the impact of abrasive elements which arise in an operating state of the electrical portable power tool, for example concrete chippings or small pebbles, on the windings 12 in the region of the winding head 22. In an operating state, the abrasive elements are guided with a cooling air flow from the fan element in the direction of the armature element 10 and can damage the windings 12 upon impact on the windings 12.

The protective unit 36 comprises a plurality of protective particles 18. The protective unit 36 is formed in one piece with the fixing unit 34. The protective particles 18 of the protective unit 36 are admixed to the matrix material 16 of the fixing unit 34 and these are applied to the windings 12 of the armature element 10 together and in a single step 14 of a method. The protective particles 18 are formed from an electrically non-conductive material. The protective particles 18 of the protective unit 36 are formed from a ceramic material. It is also conceivable, however, to form the protective particles 18 from glass, an organic material, an inorganic material or a polymer material or from any other material which appears to be expedient to a person skilled in the art. The protective particles 18 have an extent measuring at least 0.5 mm. The protective particles 18 have a greatest extent measuring between 0.5 mm and 3 mm. The protective particles 18 have a greatest extent measuring at most 4 mm. The protective particles 18 have different greatest extents lying in the range of between 0.5 mm and 4 mm. The protective particles 18 of the protective unit 36 have a geometrically undefined shape. The protective particles 18 have a flake-like form.

When applied, the protective particles 18 extend in the radial direction 38 away from the windings 12. The protective particles 18 are arranged distributed over a surface of the at least one winding 12. The protective particles 18 of the protective unit 36 are arranged spaced apart from one another and are formed from an electrically non-conductive material.

In contrast to the matrix material 16 of the fixing unit 34, the protective particles 18 of the protective unit 36 do not penetrate into the interstices between the windings 12, but instead are deposited uniformly on a surface radially outside the windings 12 and form peaks remote from the surface of the windings 12. The penetration of the matrix material 16 into the interstices of the windings 12 can achieve a uniform distribution of the matrix material 16 on the surface of the windings 12 and prevent the formation of accumulations of the matrix material 16 on the surface of the windings 12. The protective particles 18 of the protective unit 36 protrude in the radial direction 38 from the surface of the windings 12 in the region of the winding head 22. In addition, the protective particles 18 of the protective unit 36 cover the surface of the windings 12 only at certain points or in a small region. The protective particles 18 of the protective unit 36 are arranged spaced apart from one another, and some of the windings 12 remain uncovered in the region of the winding head 22, such that the removal of heat in an operating state from the windings to a surrounding area is influenced merely to a minimum extent.

By virtue of a fast rotational motion of the rotor unit in an operating state of the electrical drive apparatus, abrasive elements, for example concrete chippings or small pebbles, which are guided with a cooling air flow generated by the fan element toward the rotor unit are contacted and repelled by the protective particles 18, before they can impact on the windings 12. This reliably prevents damage to the windings 12 caused by abrasive elements.

FIG. 4 shows a schematic flow chart for a method for producing the rotor unit having the armature element 10 with the windings 12. The method comprises a step 40, in which the armature element 10 is provided with the windings 12, and a further step 14, in which the matrix material 16 intended for fixing the windings 12 is applied to the windings 12. The method comprises a further step 42, in which the matrix material 16 and the protective particles 18 are mixed with one another before they are applied to the windings 12. This step can additionally comprise a stirring process, in order to make it possible to achieve a uniform distribution of the protective particles 18 in the matrix material 16.

When the matrix material 16 and the protective particles 18 are being applied, they are distributed uniformly over the windings 12. The matrix material 16 and the protective particles 18 are applied to the windings 12 by means of a trickling method. The method has a further step 20, in which the matrix material 16 is cured. After the curing, the protective particles 18 are connected firmly and non-releasably to the windings 12 in the region of the winding head 22.

The descriptions which follow and the drawing of the further exemplary embodiment are restricted substantially to the differences between the exemplary embodiments, it also being possible in principle to refer to the drawings and/or the description of the other exemplary embodiment with respect to components of identical designation, in particular with respect to components with the same reference signs. To distinguish the exemplary embodiments, the numeral 1 is placed in front of the relevant reference signs of the further exemplary embodiment.

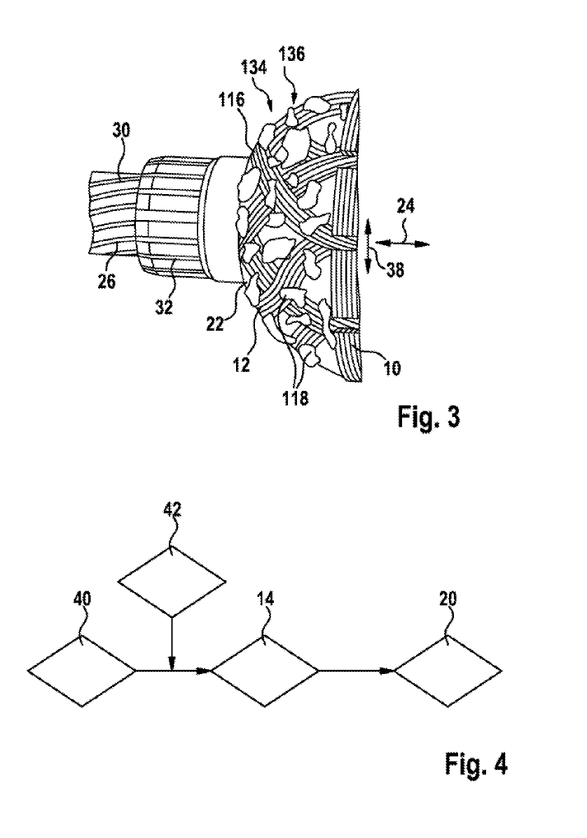

FIG. 3 shows a section of a rotor unit of alternative configuration comprising an armature element 10, a winding head 22 with windings 12, a fixing unit 134, which is intended for fixing the windings 12 on the armature element 10, and a protective unit 136, which is intended for protecting the at least one winding 12 in an operating state. The rotor unit corresponds at least substantially to the rotor unit which has already been described. The protective unit 136, however, comprises more protective particles 118 than the protective unit 36 of the rotor unit which has already been described. A surface of the windings 12 in the region of the winding head 22 therefore has a higher density of protective particles 118 of the protective unit 136 than in the rotor unit which has already been described. The fixing unit 134 corresponds to the fixing unit 34 which has already been described and comprises a matrix material 116, which corresponds to the matrix material 16.

By varying a mixing ratio between the matrix material 116 and the protective particles 118, it is possible to influence an intensity and a strength of the protection of the windings 12 against damage caused by abrasive elements present in a cooling air flow.

1. A method for producing a rotor unit having at least one armature element with at least one winding, comprising:
applying at least one matrix material to the at least one winding so as to at least partially fix the at least one winding the matrix material being applied to the at least one winding together with protective particles configured to protect the at least one winding in an operating state.

2. The method as claimed in claim 1, wherein the matrix material and the protective particles are at least partially mixed with one another before being applied to the at least one winding.

3. The method as claimed in claim 1, wherein one or more of the matrix material and the protective particles are distributed at least substantially uniformly over at least a portion of the at least one winding.

4. The method as claimed in claim 1,
further comprising at least partially curing the matrix material.

5. A rotor unit of an electrical drive apparatus, the rotor unit having at least one armature element with at least one winding and being formed by a method including:
applying at least one matrix material to the at least one winding so as to at least partially fix the at least one winding, the matrix material being applied to the at least one winding together with protective particles configured to protect the at least one winding in an operating state.

6. The rotor unit as claimed in claim 5, wherein the matrix material comprises at least one resin.

7. The rotor unit as claimed in claim 5, wherein the protective particles are arranged in a manner distributed at least substantially uniformly over a surface of the at least one winding.

8. The rotor unit as claimed in claim 5, wherein the protective particles have at least one extent that measures at least 0.5 mm.

9. The rotor unit as claimed in claim 5, wherein the protective particles are arranged at least substantially spaced apart from one another.

10. The rotor unit as claimed in claim 5, wherein the protective particles at least substantially have a geometrically undefined shape.

11. The rotor unit as claimed in claim 5, wherein the protective particles are formed at least partially from an electrically non-conductive material.

12. A drive apparatus, comprising:
at least one rotor unit having at least one armature element with at least one winding, the rotor unit being formed by a method including:
applying at least one matrix material to the at least one winding so as to at least partially fix the at least one winding, the matrix material being applied to the at least one winding together with protective particles configured to protect the at least one winding in an operating state.

13. The drive apparatus as claimed in claim 12, wherein the drive apparatus is configured to be used in a portable power tool.

14. The drive apparatus as claimed in claim 12, wherein the drive apparatus is configured as an electric motor.
